(19) United States
(12) Patent Application Publication
(10) Pub. No.: US 2021/0340396 A1
(43) Pub. Date: Nov. 4, 2021

(54) Coating For Ink-Jet Paper And Methods Of Manufacture

(71) Applicant: GOLD EAST PAPER (JIANGSU) CO., LTD., Zhenjiang (CN)

(72) Inventors: Wei WANG, Zhenjiang (CN); Guoquan WU, Zhenjiang (CN); Xianqing WANG, Zhenjiang (CN); Yefeng ZHU, Zhenjiang (CN); Weifeng TAO, Zhenjiang (CN)

(21) Appl. No.: 17/286,703

(22) PCT Filed: Dec. 20, 2018
(86) PCT No.: PCT/CN2018/122418

§ 371 Date: Apr. 19, 2021

(30) Foreign Application Priority Data
Oct. 19, 2018 (CN) 201811222742.3

(51) Int. Cl. C09D 11/322; C09D 11/037; C09D 11/106; D21H 19/38; D21H 19/60; D21H 19/58; B41M 5/52

(52) U.S. Cl. CPC C09D 11/322; C09D 11/037; C09D 11/106; B41M 5/5245; D21H 19/60; D21H 19/58; B41M 5/5218; D21H 19/385

(57) ABSTRACT

Disclosed an ink jet printing paper and a coating color used in preparing the paper, and associated methods for manufacturing the paper and its coating. The coating comprises the following components as raw materials: an anionic pigment, an adhesive and a cationic polymer, wherein the adhesive comprises a silane-modified polyvinyl alcohol. In the inventive ink jet printing paper coating, the raw material cost can be relatively low, the coating color solids content can reach 50% in many embodiments, and the coating can have a good water-retaining property. It can be suitable for large-scale production. In ink jet printing, it can give clear images with high color density, and can meet demanding requirements for high speed commercial ink jet printing.

The present invention claims the priority of the CN201811222742.3, filed on Oct. 19^{th}, 2018, the contents of which are incorporated herein by its entirety.

### FIELD OF INVENTION

The present invention relates to an ink-jet printing paper and its method of preparation.

### BACKGROUND

In the Internet age, digital ink-jet printing is rapidly growing in importance, allowing printing to be done quickly and, when needed, to be quickly corrected or modified, without the need to prepare expensive plates. This allows printing on demand to be realized, which is rapidly replacing many conventional printing processes. With the wide application of digital ink-jet printing, the demand for ink-jet printing paper and the quality requirements for such paper have also steadily increased.

Ink-jet printing paper typically can be considered as having two major layers: a paper substrate or base sheet and the surface coating. The base sheet is generally made from bleached kraft pulp and mineral fillers such as calcium carbonate. The surface coating acts to improve the uniformity of the surface of the paper, improving the suitability of the finished paper. The surface coating generally comprises pigment particles, an adhesive, a small amount of chemical aids, and the like.

Both domestically and abroad, there has been extensive development and research into porous coatings with silicon dioxide and magnesium aluminum silicate and related materials. A trend today for coating related research is the use of extremely fine particles such as nano particles of silica or other materials in combination with adhesives to provide high surface area, high ink retention, etc. for improved ink jet printing. However, such nanoparticles can be overly expensive or difficult to use in production, limiting the scope of the technology.

Examples of related coating patents include JP4466553B2 which discusses ink jet paper using fumed silica in an ink-receptive coating; Japanese Oji Paper's Chinese patent document CN 101060993A which discusses an ink-jet recording material using nanometer-scale particles such as fumed alumina, and Agfa's EP 1127706A1 which discusses various ink jet printing media and their compositions. Related ink-jet paper patents from Hewlett-Packard include U.S. Pat. No. 7,582,188, which describes the use of metal salts such as aluminum compounds and other agents. Also see the patent from New Page, CN102497993B as well as CN102497993B and CN105274897A.

In recent years, inexpensive calcium carbonate has been frequently adopted as a coating pigment and is discussed in many patents that also discuss various coating color formulations. See, for example, CN 104928976A, CN 104911950A, and CN 105274897A.

During high-speed blade coating of paper, if the solids content of the coating color is low, such as less than 50%, the resulting coverage of the coating will tend be significantly worse in terms of uniformity. Further, the basis weight of the applied coating weight will be relatively low and the drying of the coating, whether by heated rolls, infrared, or other means, will face considerable challenges that may greatly limit machine speed. Thus, it is useful to elevate the solids content as much as possible while still ensuring good runnability of the coater and uniformity of the coating.

Regarding the above-mentioned coating systems for ink-jet paper with calcium carbonate as the main pigment, while the cost is relatively low compared to silicon-based pigments such as silicon dioxide pigments or magnesium-aluminum-silicate systems, both systems suffer in high-speed coating from the general need to operate at relatively low solids content, such as less than 40% solids when aluminum silicate is the main pigment. Further, high-speed operation can result in various surface defects such as the appearance of streaks or nonuniformities or the presence of adhesive-rich strings or bars on the paper. Such challenges can limit speed, hinder quality, and increase production costs.

### SUMMARY OF THE INVENTION

In order to improve printing quality, manufacturers increasingly tend to use expensive nanoparticles as a pigment in coatings for ink-jet paper. Nevertheless, the inventors have unexpectedly discovered that by adopting common, relatively coarse pigment particles such as precipitated calcium carbonate, novel coating colors can be obtained that yield excellent printing performance that can equal or even surpass coatings made with expensive nanoparticles. The inventors have found that a combination of conventional pigment particles with silane-modified polyvinyl alcohol and a cationic polymer can provide an ink jet coating layer with excellent performance.

While the specification concludes with the claims particularly pointing and distinctly claiming the invention, it is believed that embodiments of the present invention will be better understood from the following description. In all embodiments of the present invention, all ratios are weight ratios, unless specifically stated otherwise. All ranges are inclusive and combinable. The number of significant digits conveys neither limitations on the indicated amounts nor on the accuracy of the measurements. All measurements are understood to be made at 25° C. and at ambient conditions, where “ambient conditions” means conditions under about one atmosphere of pressure and at about 50% relative humidity, unless otherwise specified.

In many embodiments, the present invention provides a means to achieve high-quality printing performance without the need to rely on specially added or expensive nanoparticles; rather, conventional pigments may be used. In some embodiments, the invention pertains to calcium carbonate pigment particles and/or other conventional pigment particles in combination with a silane-modified polyvinyl alcohol and a cationic polymer in the coating of an ink-jet printing paper. Such embodiments can provide a variety of advantages such as one or more of the following: low raw material costs, high solids content in the coating color, good uniformity in the coating, good dispersibility of the particles in preparing the coating color, good water retention, and reduced defects in high-speed, large-scale production (e.g., at speeds of 600 m/min or higher, more specifically 850 m/min or higher, or more specifically still 1000 m/min or higher, such as 1100 m/min or higher or from 800 m/min to 2000 m/min or from 900 m/min to 1600 m/min). Various embodiments pertain to both ink-jet printing paper and methods of preparing the associated coating color used to coat the ink-receiving side of the ink jet paper.

One aspect of the present disclosure pertains to a coating color for ink-jet paper, comprising on a bone-dry weight basis: 100 parts pigment particles, 5 to 12 parts adhesive, 0.5 to 10 parts cationic polymer, and an effective amount of an anionic dispersing agent, and wherein the adhesive comprises a silane-modified polyvinyl alcohol, the pigment particles comprise one or more of precipitated calcium carbonate, ground calcium carbonate, kaolin, calcined clay, titanium dioxide and talcum powder, the pigment particles' surface charge is within the range of −100 to 0 μeq/L, and the pigment has a D50 particle size in the range of 0.4 to 0.8 μm.

The present disclosure also provides a coated ink-jet printing paper with the coating made from the following raw materials: a mineral pigment, an adhesive comprising a silane-modified polyvinyl alcohol and a cationic polymer; wherein the pigment is prepared with an anionic dispersant.

In certain embodiments, the pigment is prepared in an aqueous slurry with the aid of a pigment dispersant. The dispersant is anionic or part of an overall anionic system. The dispersant may, by way of example, be selected from acrylate dispersants such as sodium acrylate products with a negative charge.

The pigment may comprise one or more of the following: precipitated calcium carbonate, ground calcium carbonate, porcelain clay, calcined clay, titanium dioxide and talcum powder. For cost or efficiency, in some embodiments the pigment is primarily calcium carbonate, such as 55% or more, 75% or more, 90% or more, or 95% or more calcium carbonate. More specifically, in some embodiments the pigment may primarily comprise precipitated calcium carbonate (PCC), such as 55% or more, 75% or more, 90% or more, or 95% or more PCC. In other embodiments, the same aforementioned content levels for the pigment may apply to ground calcium carbonate (GCC). In another embodiment, the pigment may be substantially pure calcium carbonate, such as substantially 100% PCC or substantially 100% GCC. In mixtures of precipitated calcium carbonate and ground calcium carbonate mixture, the mass ratio of precipitated calcium carbonate to ground calcium carbonate may be 1:5 or greater, 5:1 or greater, or 9:1 or greater.

It should be noted that the 5 to 12 parts adhesive is relative to 100 parts pigment on a bone dry basis, and the 0.5 to 10 parts cationic polymer is relative to 100 parts pigment on a bone dry basis.

In some embodiments, the pigment may be substantially free of inorganic nanoparticles (apart from a fraction of nanoparticles that naturally occurs in the manufacture of conventional coating fillers such as ground calcium carbonate or precipitated calcium carbonate); thus, in some embodiments, special nanoparticle materials are not added to the conventional filler materials used. Said inorganic nanoparticles can be known, commercially available inorganic nanoparticles such as nanometer silica or nanometer alumina, etc. Thus, in some embodiments, the pigment is substantially free of nanometer silica or nanometer alumina particles. Here “substantially free” can mean the pigment comprises less than 1%, less than 0.2%, or less than 0.1% by weight of the nanoparticles in question.

The preparation of the coating color can be done according to well known methods and principles known to those skilled in the art, including the use of mechanical agitation, high shear (e.g., in a homogenizer), and/or ultrasonic dispersion to assist in creating a slurry of pigment particles. The anionic dispersant may be added to the aqueous phase or to the mineral phase prior to mixing of the mineral and aqueous phase, or during mixing, or may be added after initial mixing.

The concentration of the dispersant in the suspension or slurry may be 0.2% or greater, such as from 0.5% to 10%, or from 0.5% to 5%, or from 1% to 4%, or from 0.5% to 3%, and it may be present during or after initial creation of the slurry. The dispersant may comprise one or more of poly dimethyl diallyl ammonium chloride, polyamines, and quaternary ammonium salts of acrylic polymers. Useful polyacrylic acid polymers may comprise aqueous dispersions of acrylic copolymers. The dispersant may comprise non-ionic polymers or other compounds, provided that it is adjusted to have an overall negative charge before or as it used.

In some embodiments, the pigment particle surface charge (PCD) may range from −100 (minus 100) μeq/L to 0 μeq/L, alternatively from −50 (minus 50) μeq/L to 0 μeq/L. The charge should be maintained in a range that does not cause the pigment suspension to undergo flocculation, agglomeration or other adverse reactions.

The PCD utilizes a flow potential method, combining standard titrating methods to determine the particle surface charge. The BTG instrument for PCD measurement is widely used in papermaking industry, water treatment industry, and the like.

Particle charge is measured with a BTG PCD-04 type tester, a charge measurement instrument which can process a slurry containing from 1% to 20% particles by mass. A sample size of 10 ml of a 10% slurry sample is used in a titration process to determine charge. The sample is titrated with PDADMAC aqueous solution to the equivalence point, the sample is then removed and the measuring tank is cleaned with the aid of ultrasonic waves, and the system is flushed with cleaning solution for decontamination.

In some embodiments, the pigment has a D50 particle size of 0.4 to 0.8 μm. D50 refers to that particle size for which 50% of the particles are smaller, as measured by an X-ray measurement in a sedimentation system, described below. D50 is also known as median diameter or median particle diameter.

Particle size measurement of the coating pigment is made using a Micromeritics Corporation (Norcross, Ga., USA) Sedigraph® 5120-type automatic sedimentation type particle size analyzer using X-rays for measurement of particle size distribution. The instrument is operated according to standard procedures, including calibration with standardized particles.

In the particle size distribution curve obtained by X-ray measurement during gravitation settling, in some embodiments the highest peak will typically appear in the particle size of 0.4 to 0.8 μm.

The mass fraction of the particles as a function of size increment can be obtained from the sedimentation-based particle size analysis. In many embodiments, at least 60% by weight of the pigment particles are greater than 0.2 microns, or, alternatively, greater than 0.4 microns or greater than 0.5 microns. Alternatively, at least 70% by weight of the pigment particles are greater than either 0.2 microns, 0.5 microns, or 1.0 microns. In another embodiment, at least 80% of the mass of the pigment particles are greater than either 0.2 microns, 0.5 microns, or 1.0 microns. In yet another embodiment, at least 90% of the mass of the particles is greater than either 0.2 microns, 0.5 microns, or 1.0 microns Thus, for example, in one embodiment at least 95% by weight of the particles are in a size range greater than 0.2 microns, such as from 0.2 to 3.0 microns or from 0.4 to 3.0 microns.

The lower limit for any of the size ranges disclosed herein may be selected from any one of the group consisting of 0.2, 0.3, 0.4, 0.5, 0.7, 1.0, 1.2, and 1.5 microns. An upper limit, if desired or applicable, for any of the size ranges relative to pigment particles pertaining to the present invention may be selected from any one of the group consisting of 1.5, 2.0, 2.5, 3.0, 4.0, 5.0, 8.0, and 11 microns.

When the pigment is precipitated calcium carbonate, the particle size distribution from commercially produced particles tends to be relatively narrow, and the resulting coating can be relatively high in porosity, resulting in good capture of ink jet droplets and strong capillary action to promote rapid drying of the aqueous ink.

In some embodiments, the silane-modified polyvinyl alcohol can have a degree of polymerization degree ranging from 500 to 3000, or more specifically from 1000 to 2000, 1400 to 1800 or from 1600 to 1950. The silane-modified polyvinyl alcohol may have physicochemical parameters such as a viscosity of from 5 to 50 cps (measured at a concentration of 4% in water at 20° C. using a Brookfield Viscometer with a #3 rotator at 60 rpm; note that a viscosity of 1 centipoise or cps is equivalent to 1 mPa s), with a hydrolysis degree (mol %) of 90% or greater, such as from 95 to 99.9%, with non-volatiles component by weight of from 92% to 100%. More specifically, in some embodiments the viscosity at 4% concentration in water at 20° C. may be from 20-30 mPa s, the hydrolysis degree can be greater than 85% such as from 95% to 99% or from 98% to 99%, non-volatiles may range from 98 to 100%, the ash content can be less than or equal to 0.2%, the pH value can range from 4 to 8 or more specifically from 5 to 7, and if present the sodium acetate concentration may range from 0.01 to 0.5%, such as about 0.2%. In this and in other cases discussed herein, each of the possible ranges listed may be considered individually or in various combinations. In general, every listed potential limitation need not apply to any or all or the embodiments within the scope of the present disclosure, unless otherwise specified.

In some embodiments, the silane-modified polyvinyl alcohols may be produced by vinyl acetate and vinyl-tri-alkyloxy silane that are copolymerized, after which the copolymer may be directly hydrolyzed in alkali solution. The silane-modified polyvinyl alcohol may contain from about 0.5 to 1.0 mol % of silyl group as vinyl silane units, by way of example with a degree of polymerization of about 1000 to 3000, and the degree of hydrolysis for the vinyl acetate units can be greater than 95% such as 99% or more.

Wacker Chemical's patents CN 101180330B and U.S. Pat. No. 7,052,773 disclose a silane-modified polyvinyl alcohol preparation technology. The silane modified polyvinyl alcohol can be prepared by mixing vinyl acetate with vinyl-tri-alkyloxy silane and copolymerizing. The copolymer is then directly hydrolyzed in alkali solution. Other known methods of producing silane-modified PVA may be employed.

The resulting silane modified polyvinyl alcohol may contain from about 0.5 to 1.0 mol % of silyl group as vinyl silane units, the degree of polymerization may range from 500 to 5000 such as from about 1000 to 3000 or from 1300 to 2000 or more specifically about 1700.

The silane modified polyvinyl alcohol on a dry basis may be present in the coating color at a relative amount of 1 to 15 parts, alternatively 5 to 12 parts, or more specifically from 6 to 9 parts, such as from 8 to 9 parts. It should be noted that the amount of the silane modified polyvinyl alcohol is relative to 100 parts pigment on a bone dry basis,

In some embodiments, the cationic polymer can be selected from the group consisting of one or more of: polyethyleneimine, poly hydroxypropyl dimethyl ammonium chloride, poly quaternary ammonium salt, polyvinylpyridine, poly amine sulfones, poly (2-hydroxyethyl methacrylate), poly acrylic acid dialkyl amino ethyl acrylate, poly (2-hydroxyethyl) methacrylamide, poly (2-hydroxyethyl) acrylamide, poly epoxy amine, polyamide, dicyandiamide-formaldehyde condensates, polyethylene amine, poly allyl amine compounds and hydrochloric acid salts thereof, and poly diallyl dimethyl ammonium chloride, a copolymer formed by diallyl dimethyl ammonium chloride and acrylamide monomers and the like, poly diallylmethylamine hydrochloride, dimethyl amine-epichlorohydrin condensation polymers, dimethyl amine-epichlorohydrin or diethylene triamine-epichlorohydrin condensation polymers and the like, as well as polycondensates formed by aliphatic mono amine (such as diethylene triamine-epoxy chloropropane polycondensate) or aliphatic polyamine compounds with epoxy halopropane compounds.

The cationic polymer may comprise one or more of dimethyl amine-epichlorohydrin condensation polymers, polyethyleneimine, poly diallyl dimethyl ammonium chloride, poly hydroxypropyl dimethyl ammonium chloride and poly quaternary ammonium salt, such as poly diallyl dimethyl ammonium chloride and/or poly quaternary ammonium salts.

Without wishing to be bound by theory, because digital ink-jet printing inks tend to be anionic, when the coating contains a cationic polymer, it is believed that the cationic polymer can in some cases be helpful in capturing and retaining the aqueous ink droplets that are ejected by the printer into the surface of the paper.

In some embodiments, the cationic polymer on a dry basis relative to 100 parts pigment may be from 0.5 to 10 parts, alternatively from 2 to 5 parts, such as from 3 to 4 parts.

The molecular weight of the cationic polymer can be any suitable level such as a range from 400 to 100,000. The cationic polymer prior to combination with the pigment slurry may have, by way of example, a solids content of from 20% to 60% such as from 35% to 50% or about 40%, a viscosity of 500 to 5000 cps (measured at a concentration of 4% in water at 20° C. using a Brookfield Viscometer with a #4 rotator at 60 rpm), such as from 2000 to 3000 cps. The pH may be from 2 to 9, such as from 2 to 5 or from 2 to 4 or from 2 to 3.

In some embodiments, the coating material may further comprise a water resistant agent. The water resistant agent may be selected from one or more of epoxies, ammonium zirconium carbonate (AZC), poly ammonia polyureas (PAPU) and the like. The water resistant agent may be provided in any useful amount such as, on a dry basis relative to 100 parts pigment, by adding 0.2 to 3 parts to the coating color, or by adding 0.6 to 1.5 parts, or from 0.8 to 1.3 parts.

The solids content of the coating colors of the present disclosure may be more than 50%, and may have solids levels equal or greater than, say, 52%, 53%, 55%, 60%, or 65%, with upper concentration limits that may be, for example, when applicable, 55%, 60%, 65%, 68%, or 70%, giving possible ranges such as from 52% to 60%, etc. For high-speed blade coating, the inventive coating colors may be applied at any practical speed such as speeds of at least 600 m/min, 800 m/min, 1000 m/min, 1100 m/min or 1200 m/min, with upper limits if desired and appropriate that may be selected from 1300 m/min, 1500 min/min, and 1700 m/min.

Some embodiments also pertain to a method for the preparation of the ink-jet printing paper coating, which may comprise the following steps: preparing the ink-jet printing paper coating raw materials, combining them according to known methods in the art, uniformly mixing, and then applying to a paper basesheet to form a coating and then drying the coating.

Some embodiments also pertain to an ink-jet printing paper comprising: a paper basesheet having two sides, at least one side of which having a surface coating, wherein the surface coating is made from a coating color comprising the following raw material components, on a bone-dry basis: 100 parts of pigment particles, 5 to 12 parts of adhesive and 0.5 to 10 parts of cationic polymer and an anionic dispersing agent for dispersing the pigment particles, wherein the adhesive comprises a silane-modified polyvinyl alcohol, the pigment particles comprises at least one of precipitated calcium carbonate, ground calcium carbonate, porcelain clay, calcined clay, titanium dioxide and talcum powder, and wherein the pigment has a D50 particle size from 0.4 to 0.8 μm, and wherein at least 60% by weight of the pigment particles have a particle diameter of 0.2 μm or greater, and at least 50% by weight of the pigment particles have a particle diameter from 0.2 μm to 2 μm; and wherein solid black color blocks printed on the ink-jet printing paper have a black color density greater than 1.1.

In some embodiments, an ink-jet printing paper structure is disclosed comprising a paper substrate with a basis weight that may, for example, be from 20 to 300 gsm (g/m²), or from 30 to 200 gsm, from 40 to 180 gsm, from 40 to 120 gsm, or from 50 to 130 gsm. At least one surface of the paper substrate is then coated with the coating color of various embodiments disclosed herein and then dried, cut to the desired size, and packaged to provide an ink jet paper product.

The base paper may be any known paper, including papers with an ash content from 0 to 25%, or from 7.5 to 20%, such as at least 10%, 14% or 18.5% ash with upper limits when applicable that independently may be, for example, 20%, 30%, 40%, 50%, or 65%. The ash component may be primarily ground calcium carbonate and/or precipitated calcium carbonate, or other known mineral pigments.

The paper substrate may be uncoated paper, unsized paper, sized paper, or sized and coated paper, which may then be further coated according to the present disclosure. Sizing, as is well known in the art, refers to applying a solution or suspension to one or more surfaces to control the intake of water by the sheet and thus maintain the stability of the size of the paper, or control absorption of ink, enhance paper smoothness, or advance other properties of the paper such as its printing performance or ability to receive a subsequent coating while maintaining good properties.

A measure of water absorption behavior for the basesheet is the Cobb test value, such as described in the China test method GB/1540-2002, NEQ ISO 535: 1991. The basesheet may have a Cobb value, for example, from 18 to 120 g/m², such as from 20 to 100 g/m², from 30 to 90 g/m², or from 50 to 110 g/m². The Cobb value, also referred to as paper and paperboard surface water absorption value, refers to the unit area of the paper and paperboard at a certain pressure and temperature, the surface within a predetermined time period, with the amount of water absorbed expressed in units of gsm.

The basesheet may be any suitable paper known in the art. The coated paper can be prepared by the following steps of: forming or providing a basesheet, coating at least one side of the basesheet, drying the coating, etc. The coating steps can be selected from methods known the art such as blade coating, wire coating, metered rod coating, curtain coating, spray coating, etc. The drying step can be selected from known drying methods for coated paper such as infrared drying, convection drying, and drum drying. During the coating process, a single coat or multiple coats may be applied, and the coating color need not be identical in all layers. After drying, calendering steps may be undertaken to increase surface smoothness.

In some embodiments, the coated paper substrate prior applying the surface coat of the ink-receiving color (ink receiving coating layer) may have a surface roughness from 4.0 to 8.0 μm, as described ISO 8791-4:2007, a method using the Parker Printsurf device to examine the ability of a surface to form a seal against a gasket to resist leakage of air. The rougher the paper, the greater the airflow, and the airflow measurements can be expressed in terms of an effective gap height that can be characterized as a measure of surface roughness. After receiving the surface coating (the ink receiving coating layer), the surface roughness in some embodiments may be substantially less, such as from about 1.5 to 3 or from 1.4 to 2.5.

The mineral pigment also may have 65% or more of the pigment particles with an effective diameter based on the sedimentation technique described above less than or equal to 2 μm. The pigment is formed into an aqueous coating color comprising an adhesive which may comprise polyvinyl alcohol, latex, starch and the like, in combination with one or more coating aids for adjusting coating and/or the performance of the coating. Common coating aids include a water resistant agent, a rheological agent, water-retaining agents, dyes, and fluorescent brighteners (OBA), etc.

Without being limited by theory, it is believed that good performance in printing is more likely when the roughness of the coated paper substrate prior applying the ink-receiving colors is in the range of 4.0 to 8.0 μm. Obviously, if the surface is too rough, poor print uniformity may occur. But a surface that is too smooth may lack adequate porosity for rapid ink drying. For example, if pigment particles are too fine and create too dense a surface with only very small pores, ink may not be able to penetrate the surface enough for good drying, and subsequent handling of the incompletely dried sheet may result in smearing or other defects.

Further, we have observed that the porosity of the inventive coated paper generally has a positive impact on drying. Other coated ink-jet papers known in the art can present a printing surface that is relatively dense and non-porous, using, for example, amorphous silica pigment, nano-grade calcium carbonate pigments and other nano particles that, in combination with the presence of an adhesive, can form a dense coating with the adhesive preferentially on the surface. If the roughness is below about 4 microns, the result may be poor drying in such papers. The basis weight of the inventive coating may be at least 8 gsm (referring to the basis weight applied to a single side) or at least 10 gsm or at least 15 gsm or at least 20 gsm, such as from 8 gsm to 100 gsm, or from 8 gsm to 25 gsm, or from 10 gsm to 80 gsm, or from 12 gsm to 30 gsm, or from 15 gsm to 35 gsm, or from 20 gsm to 60 gsm, from 20 gsm to 100 gsm, or from 24 gsm to 40 gsm.

In some embodiments, the paper basesheet comprises a base paper or a coated paper, wherein the roughness of the coated paper prior to application of the surface coating is from 4.0 to 8.0 μm.

In some embodiments, when the paper basesheet is a base paper, the coating amount of the surface coating is at least 20 gsm or more.

In some embodiments, when the paper basesheet is a coated paper, the coating amount of the surface coating may be from 8 gsm to 15 gsm.

In the coating of a coated paper basesheet, the pigment can be any conventional pigment known in the art. The pigment may comprise a component selected from the group consisting of precipitated calcium carbonate, ground calcium carbonate, porcelain clay, calcined clay, titanium dioxide and talcum powder, or selected from precipitated calcium carbonate and/or ground calcium carbonate. In some embodiments when the pigment is a mixture of precipitated calcium carbonate and ground calcium carbonate, the amount of the precipitated calcium carbonate may be equal to or more than 60% and less than 100%, or equal to or more than 90% and less than 100%, and the above percentage is the mass percentage of the precipitated calcium carbonate relative to the total mass of pigment. When the pigment is a mixture of precipitated calcium carbonate and ground calcium carbonate, the mass ratio of the precipitated calcium carbonate to the ground calcium carbonate may be 9:1.

The adhesive in the coating of the coated paper basesheet may comprise one or more of polyvinyl alcohol (PVA), carboxymethyl cellulose (CMC), starch, styrene-butadiene latex (SB), styrene-n-butyl acrylate latex (SA) and polyvinyl acetate latex (PVAC) (in some embodiments, such components and other variations described herein for adhesives in a basesheet coating may also be present in the coating color applied to the basesheet in making the ink jet paper of the present invention). In some embodiments, the adhesive comprises both polyvinyl alcohol (PVA) and/or styrene-butadiene latex, and in some embodiments may be substantially all PVA or substantially all a mixture of PVA and SB. The PVA may comprise silane-modified PVA or a combination or silane-modified PVA and conventional PVA.

For mixtures of PVA and SB in the adhesive, relative to 100 dry arts of pigment, the coating color may comprise on a dry basis 3 to 10 parts PVA, alternatively 3 to 6 parts PVA, or from 5 to 9 parts PVA, and may further comprise from 0 to 10 parts or 1 to 10 parts or 2 to 10 parts SB, or less than 3 parts SB.

The silane-modified polyvinyl alcohol may have a degree of polymerization from 500 to 3000, such as from 900 to 2000 or from 1400 to 1800. It may also have a viscosity (4% AQ, 20° C., #3 Brookfield rotor at 60 rpm) of 5 to 50 cps, a hydrolysis degree (mol %) of 90% or greater such as 95-99.9% or 98% to 99%, and comprise 92% to 100% of non-volatiles by weight. The silane-modified polyvinyl alcohol physicochemical parameters are: viscosity (preferably 4% AQ, 20° C., #3 rotor at 60 rpm) 20-30 mPa s. The ash content of the PVA may less than or equal to 0.2%, and it may have a pH value of from 4 to 8 such as from 5 to 7. The styrene-butadiene latex (SB) may have a gel content (a measure of the degree of crosslinking in the latex) greater than 60%, such as from 70-80%.

The silane-modified polyvinyl alcohol can be prepared by mixing vinyl acetate with vinyl-tri-alkyloxy silane and copolymerizing, then the copolymer is directly hydrolyzed in alkali solution to prepare it. The silane-modified polyvinyl alcohol may comprises from about 0.5 to 1.0 mol % of silyl group as vinyl silane units. Other known methods may be used.

The adhesive is added in an amount to ensure that the coating color has a specified solids content such as at least 50% solids or at least 55% solids such as from 55% to 75% solids or from 55% to 63% solids. After printing, the coated paper may have an IGT surface strength (a measure of surface strength in printing, measured according to ISO3783:2006) of at least 160 cm/s such as at least 180 cm/s. The surface strength before printing may be higher such at least 180 cm/s or from 180 cm/s to 250 cm/s.

The products according to various embodiments herein may provide excellent printing results such as a Gap Test Grayscale Value (described hereafter) of 180 or greater or 200 or greater.

The solids content of the coating of the coated paper may be more than 50%, or more than 60%, for example, when applicable, 55%, 58%, 62%, 68%, or 70%, giving possible ranges such as from 52% to 70%, etc. For high-speed blade coating, the coating of the coated paper may be applied at any practical speed such as speeds of at least 600 m/min, 800 m/min, 1000 m/min, 1100 m/min or 1200 m/min.

The coating amount of the coating of the coated paper may be from 8 gsm to 15 gsm, or 12 gsm to 15 gsm.

As used herein, “bone-dry” refers to the mass of the material without solvent or liquid carrier, particularly water, and can generally be measured after drying.

As used herein, the mass cumulative percentage is obtained by summing the mass fraction of the particles from a lower limit to an upper limit.

As used herein, the mass fraction refers to a ratio of the mass of the particles with indicated diameter to the total mass of the particles.

Some but not necessarily all embodiments disclosed herein may display one or more of the following potential benefits, bearing in mind that many embodiments within the scope of the present disclosure will need or need not display more than one of the following benefits:
Low raw material cost
Ability to use conventional papermaking and coating equipment
Ability to use conventional ink-jet paper
Ability for the coated paper to be produced at high speed with high-speed blade coating systems at speeds of 1000 m/min or higher
Crisp imaging similar to or better than commercial papers containing added nanoparticles or other expensive additives
Ability obtain crisp imaging and high color density without added aluminum salts or specialty nanoparticles, relying instead on commonly used PCC, GCC, or other conventional pigment particles.
Applicability to numerous coating application systems, such as a rod coater, air knife coater, a curtain coater, a film coating machine, etc.

### BRIEF DESCRIPTION OF THE DRAWINGS

FIG. 1 is a schematic of cross-section of the coated ink-jet paper depicting several versions of the invention.

FIG. 2 shows a printed paper of Example 1 showing the damage that can be caused by friction (rubbing) on the printed image.

FIG. 3 shows a printed image on the paper of Comparative Example 3 showing the damage that can be caused by friction (rubbing) on the printed image.

FIG. 4 shows a printed reference image on the paper of Example 3.

FIG. 5 shows a printed reference image on the paper of Comparative Example 1.

FIG. 6 shows a printed reference image on the paper of Example 3.

FIG. 7 shows a printed reference image on the paper of Comparative Example 1.

FIG. 8 shows part of the original reference pattern from the original reference image file.

FIG. 9 shows a close up of portion of the reference image used in the Gap Test to obtain the Gap Test Grayscale Value, here showing the region to be selected for measurement of the mean grayscale value.

FIG. 10 shows a portion of the printed reference image from Example 3 showing a selection being made for measurement.

FIG. 11 shows a an enlarged view of FIG. 10.

FIG. 12 shows a portion of the printed reference image from a comparative example with a commercial ink-jet paper from New Page Corp. believed to have been manufactured with nanoparticles in the coating.

FIG. 13 shows a portion of the printed reference image from a comparative example with a commercial ink-jet paper from Mitsubishi Paper.

FIG. 14 shows a portion of the printed reference image from an early ink jet coating formulation at Gold East Paper.

FIG. 15 shows a portion of the printed reference image from Example 3.

FIG. 16 shows a portion of the printed reference image from Comparative Example 1.

FIG. 17 shows a portion of the printed from Example 3.

FIG. 18 shows a portion of the printed from Comparative Example 1.

FIG. 19 shows a portion of the printed from Example 3.

FIG. 20 shows a portion of the printed from Comparative Example 1.

### DETAILED DESCRIPTION

Below various embodiments are disclosed based on the drawings in order to illustrate further details. The invention as claimed is not meant to be limited by the scope or nature of the specific embodiments described.

In the following embodiments, experimental methods without specific conditions are selected according to conventional methods and conditions, or according to well-known standard specifications.

In following examples, the solids content of the coating color can be correspondingly adjusted according to the coating method or coating apparatus. For example, for optimum coating operation with a blade coater the solids content of the coating color can be adjusted to above 50%, as needed. For air knife type or curtain coating, the solids content of the coating color may be adjusted to below 50%, such as from 40% to 50%.

Examples according to some embodiments of the present invention, as discussed below, show a Gap Test Grayscale Value of at least 180 (on a scale where 0 is black and 255 is white).

### Examples 1-3

Examples 1 to 3 were prepared from paper and coating colors as listed in Table 1 below. The pigment was selected from ground calcium carbonate and precipitated calcium carbonate or combinations thereof. The coating was prepared using conventional mixing technology to prepare a uniform coating color from individual components.

The printing surface of coated ink jet paper was coated using precipitated calcium carbonate pigment combined with suitable anionic dispersant added in quantities sufficient to adjust the PCD values between −100 to 0 μeq/L. The pigment particle size parameter DP50 based on mass fraction was between 0.4 to 0.8 μm, with more than 70% of the pigment particles by mass having an effective diameter greater than 0.2 microns.

In some embodiments the fraction of particles between 0.2 to 2 microns in effective diameter can have a mass cumulative percentage greater than 50%, greater than 70%, greater than 80% (as was the case here, as indicated below), or greater than 90%. (In some embodiments, the pigment is substantially free from added nanoparticles, and more specifically substantially free from added nanometer size silica, alumina or other inorganic nanoparticles, with “nanometer size” as used herein referring to particles with a DP50 parameter less than 0.1 microns.)

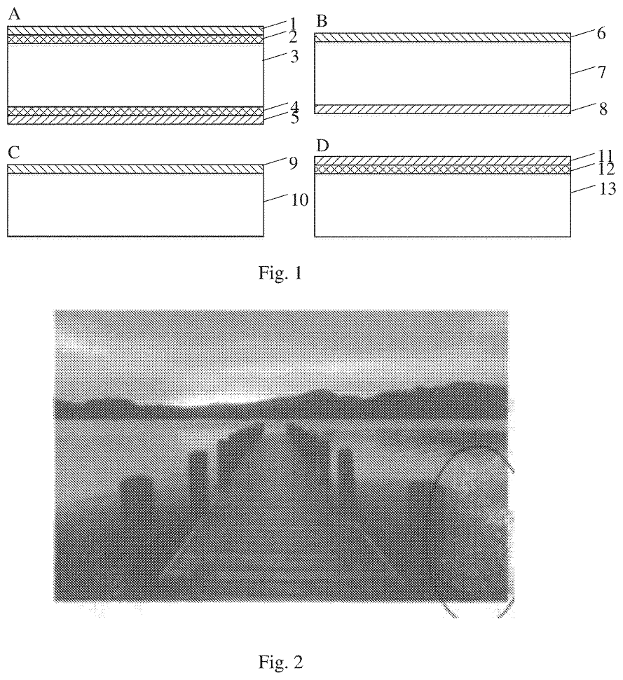

In Examples 1 to 3, both sides of the basesheet were coated to give a structure similar to FIG. 1A, which shows a basesheet 3 with a first coated side on the upper surface comprising a base coating layer 2 and a top coating layer 1, or simply the topcoat, which serves as an ink receiving layer. The second side of the basesheet 3 has its own respective base coating layer 4 and a topcoat layer 5. The coating were applied in multiple steps, then given final drying and then calendaring to form coated ink jet paper. For Examples 2 and 3, the coated ink-jet printing paper preparation method was the same as in Example 1.

The topcoat formulation in Examples 1 to 3 comprised silane-modified polyvinyl alcohol with a viscosity (in a 4% aqueous solution at 20° C.) of 20.0 to 30.0 mPa s, a hydrolysis degree of 98.0 to 99.0%, non-volatiles comprising 98 to 100% of the PVA, an the ash content less than or equal to 0.2%, and a pH value of 5 to 7, with about 0.2% sodium acetate.

The silane modified polyvinyl alcohol can be prepared by mixing vinyl acetate with vinyl-tri-alkyloxy silane and copolymerizing. The copolymer is then directly hydrolyzed in alkali solution. Wacker Chemical's patents CN 101180330B and U.S. Pat. No. 7,052,773 disclose a silane-modified polyvinyl alcohol preparation technology. The resulting silane modified polyvinyl alcohol may contain from about 0.5 to 1.0 mol % of silyl group as vinyl silane units, the degree of polymerization is about 1700, and the degree of hydrolysis for the vinyl acetate units can be greater than 99%.

The cationic polymer prior to combining with the other ingredients of the coating color had a solids content of about 40%. a viscosity (4% aqueous solution at 20° C.) of 2740 cps, and a pH of 2.2.

### Example 4

Example 4 was prepared in the same way as Example 1, but with a structure generally following FIG. 1B, with a first topcoat 6, a basesheet 7, and a second topcoat 8 on the opposing side of the basesheet. Compared to Example 1, the base coat was left out. Here the coating basis weight was 24 g/m² on each side.

The basis weight of the basesheet in this example was 55 g/m², the ash content was 14%, and the Cobb value was 21 g/m².

### Example 5

Example 5 was prepared in the same way as Example 1, but with a structure corresponding generally to FIG. 1C, such that the basesheet is only coated on nested embossing side. FIG. 1C shows a basesheet 10 with coated side on the upper surface comprising a top coating layer 9. The basis weight of the coating was 24 g/m², and the basis weight of the basesheet was of 55 g/m². The ash content of the base sheet was 14%, and the Cobb value was 21 g/m².

### Example 6

Example 6 was generally prepared in the same way as Example 1, but with a structure corresponding generally to FIG. 1D. Thus, the paper is coated on only one side of the basesheet 13, with a base coating 12 and a top coat 11.

TABLE 1

| | | | | | | Comp. | Comp. |
|---|---|---|---|---|---|---|---|
| | Reference | | Example 1 | Example 2 | Example 3 | Ex. 1 | Ex. 2 |
| Base- | Coated sheet | | 63 | 85 | 143 | 128 | 157 |
| sheet | basis weight, gsm | | | | | | |
| Base | Pigment | | PCC, 100 | PCC, 100 | PCC, 90 parts + | — | — |
| coat | | | parts | parts | GCC, 10 parts | | |
| | Silane- | Parts | 8 | 6 | 3 | — | — |
| | mod. | Deg. of | 1400-1800 | 1400-1800 | 1400-1800 | — | — |
| | PVA | Polym. | | | | | |
| | SB | Parts | 0 | 5 | 9 | — | — |
| | latex | Gel | — | 70-80% | 70-80% | — | — |
| | | content | | | | | |
| | Solids content, % | | 55 | 58 | 62 | — | — |
| | Coating weight, gsm | | 8 | 12 | 15 | — | — |
| Top coat | Pigment | Pigment | PCC 100 parts | PCC 100 | PCC 100 parts | — | — |
| | | type | | parts | | | |
| | | Dispersant | One or more of acrylic copolymer aqueous | | | — | — |
| | | type | dispersion, poly dimethyl diallyl ammonium | | | | |
| | | and | chloride, polyamines, quaternary ammonium | | | | |
| | | dosage | salts of acrylic polymer, with a dosage of | | | | |
| | | | 15-20 kg/ton of pigment (dry weight) | | | | |
| | Silane- | Parts | 6 | 8 | 9 | — | — |
| | mod. | Deg. of | 1400 to 1800 | 1400 to | 1400 to 1800 | — | — |
| | PVA | Polym. | | 1800 | | | |
| | Cationic | Type | poly diallyl | poly diallyl | poly quaternary | — | — |
| | polymer | and | dimethyl | dimethyl | ammonium salt, 5 | | |
| | | dosage | ammon. | ammon. | parts | | |
| | | | chloride, 2 | chloride, 3.5 | | | |
| | | | parts | parts | | | |
| | | Mol. wt. | 400 to 100000 | 400 to | 400 to 100000 | — | — |
| | | | | 100000 | | | |

| | | | | | | |
|---|---|---|---|---|---|---|
| | Wear-resistant | Epoxy resin, | Epoxy resin, | PAPU, 1.3 parts | — | — |
| | agent | 0.6 parts | 1.0 parts | | | |
| | Solids content, % | 55 | 53 | 52 | — | — |
| | Coating weight, gsm | 15 | 12 | 10 | — | — |
| Ink jet | Drying behavior | Immediate | Immediate | Immediate drying | Immed. | Dried |
| printing | | drying after | drying after | after printing | after | slowly |
| | | printing | printing | | printing | (over 60 |
| | | | | | | sec.) |
| | Color density: K | 1.25 | 1.27 | 1.27 | 1.22 | 0.98 |
| | Color density: M | 1.13 | 1.15 | 1.14 | 1.11 | 0.87 |
| | Color density: C | 0.88 | 0.90 | 0.89 | 0.84 | 0.65 |
| | Color density: Y | 0.96 | 0.96 | 0.97 | 0.98 | 0.90 |

Remarks: (1) In evaluating the drying behavior after printing, a finger was used to lightly rub the printed image. If the ink was already dry, then there would be no ink on the paper after rubbing. (2) In Table 1, for the base coat and top coat formulations, the listed parts of the components are relative to 100 parts dry pigment in the coating colors, all on a dry basis. (3) The color density test device is an X-Rite 528 spectroscopic density meter (Estelle Corp., Shanghai, affiliated with Danaher in the U.S.), used according to test standard GB/T 35390-2017. (4) For Examples 1 to 3, the pigment particle surface charge was −50 mu eq/L. (5) For Examples 1 to 3, the pigment had a D50 particle size of 0.4-0.8 μm. (6) For Examples 1-3, the roughness of the coated paper substrate prior to applying the ink-receiving coating was 4.0 to 8.0 (7) The color density printing uses solid color block printing. Since color density may vary depending on the model of inkjet printer used, the printer employed herein is a commercially available EPSON L810 type ink jet printer with continuous ink supply using 6 color cartridges. (8) After printing, allow the sheet to dry for 30 seconds or more before further processing or testing.

For the topcoat coating color of Examples 1-3, using an X-ray gravity sedimentation pigment particle size detection method, the data in Table 2 was obtained.

TABLE 2

| Diameter | Diameter | | Cumulative | Incremental |
|---|---|---|---|---|
| upper | lower limit, | Mean | mass | mass |
| limit, μm | μm | diameter, μm | distribution, % | distribution, % |
| 10.0 | 8.0 | 8.944 | 99.6 | 0 |
| 8.0 | 6.0 | 6.928 | 99.4 | 0.2 |
| 6.0′ | 5.0 | 5.477 | 99.0 | 0.4 |
| 5.0 | 4.0 | 4.472 | 98.7 | 0.3 |
| 4.0 | 3.0 | 3.464 | 98.3 | 0.4 |
| 3.0 | 2.0 | 2.449 | 96.6 | 1.7 |
| 2.0 | 1.5 | 1.732 | 94.1 | 2.5 |
| 1.5 | 1.0 | 1.225 | 88.1 | 6.0 |
| 1 | 0.8 | 0.894 | 81.9 | 6.2 |
| 0.8 | 0.6 | 0.693 | 67.1 | 14.9 |
| 0.6 | 0.5 | 0.548 | 53.6 | 13.5 |
| 0.5 | 0.4 | 0.447 | 36.8 | 16.8 |
| 0.4 | 0.3 | 0.346 | 20.4 | 16.4 |
| 0.3 | 0.2 | 0.245 | 16.3 | 4.1 |

Remarks: In Table 2, each incremental range considered for particle diameter has an upper limit and a lower limit. About 16.3% by weight of the particles are below 0.3 microns, and about 12.2% by weight of the particles are below 0.2 microns (16.3% cumulative at 0.3 microns minus the 4.1% weight fraction between 0.2 and 0.3 microns) so it can be said that over 70% of the particles are greater than 0.2 microns in diameter, or over 80% are greater than 0.2 microns in diameter, since about 88% by weight as measured were actually above 0.2 microns in diameter.

### Comparative Example 1

Nanomater silicone dioxide was the ink-jet paper coating pigment from a commercial ink jet paper.

### Comparative Example 2

Ordinary offset printing coated paper was used.

### Comparative Example 3

Comparative Example 3 generally followed Example 1, but the topcoat formulation employed an ordinary polyvinyl alcohol instead of silane-modified polyvinyl alcohol.

### Comparison of Color Density Values

When ink jet droplets contact a paper, there is a combination of infiltration into the paper and surface diffusion of the wet ink. For best results (minimum penetration into the paper and low spreading of the ink), the ink should dry quickly and be retained on the upper surface of the topcoat. An important measure of image quality of particular importance in ink jet printing is the color density. If diffusion of the ink occurs to a high degree, the resulting image will not be clear due to the spreading of the ink. To examine the quality of the printing for Examples 1-3 and for the comparative examples, the color density of a printed image was measured. The specific test employed a commercially available EPSON L810 type ink jet printer with continuous ink supply using 6 color cartridges, ink model T674. Printing was based on the KCMY color model using inks that respectively are black, cyan, magenta, and yellow (4 colors). Color density was evaluated using an X-Rite® color density instrument (Estelle Corp. 528 spectroscopic density meter), according to the Chinese test standard GB/T35390-2017). Results for each of the 4 colors are shown in Table 1.

As can be seen from Table 1, inventive Examples 1-3 provide similar good results in printing. After printing and drying, the overall color density for Examples 1-3 was higher than that of Comparative Example 1 and for Comparative Example 2 with an ordinary offset printing coated paper. In Comparative Example 2, the ink-jet printing did not dry rapidly, allowing high diffusion and penetration into the sheet, with a resulting low value for color density, significantly lower than for the inventive Examples 1-3.

### Wet Friction Resistance

Example 1 and Comparative Example 3 were printed and subjected to a printing paper wet friction resistance test, using the following method: The printed sheets from Example 1 and Comparative Example 3 each received a drop of water (estimated 0.5 ml) applied after printing. After allowing the ink to absorb for 10 seconds, an average-sized human index finger pad is placed flatly on the paper providing a contact area of about 1 square cm, and with an applied load of about 0.5 MPa of pressure, based on measurement with a laboratory balance. During the test, the finger is moved back and forth over a span of 5 cm for a total of 5 times (forward, backward, forward, backward, then forward again), maintaining substantially constant force, at a uniform speed over a total time of about 5 seconds. Similar treatment is applied to each sample tested for wet friction resistance.

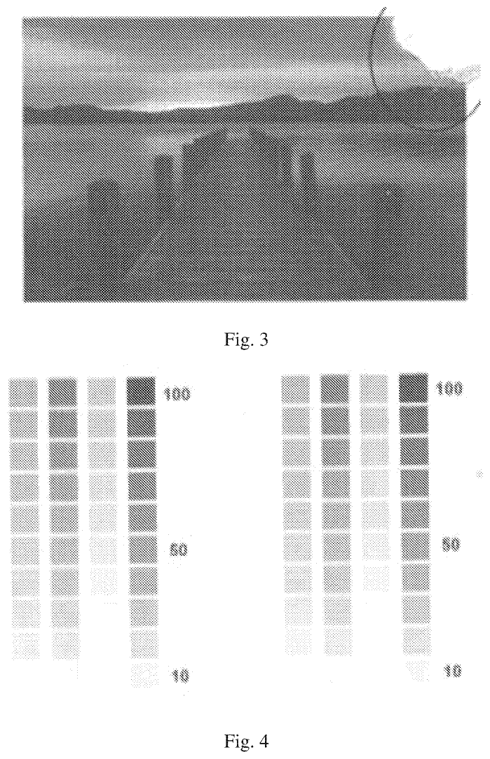

FIG. 2 shows the effect of rubbing a wet spot for the printing paper of Example 1, and FIG. 3 shows the results after rubbing the wet spot for the paper of Comparative Example 3. It can be seen that the paper of inventive Example 1 not only has improved absorptivity and fixation of ink-jet ink, and but also has better wet friction resistance.

### Analysis of Print Clarity Using Gap Test Grayscale Values

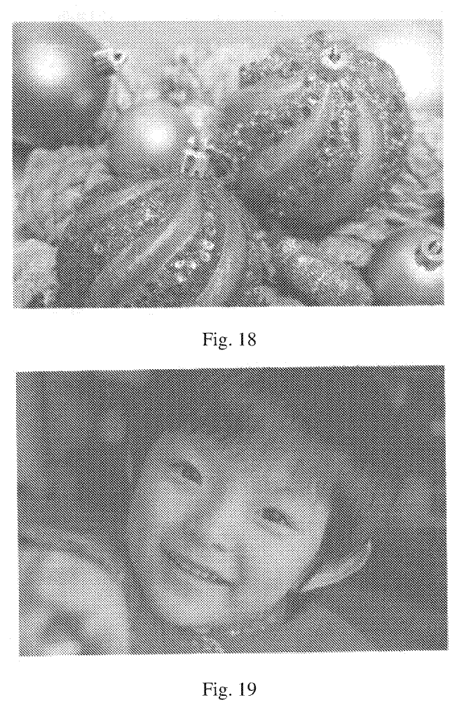

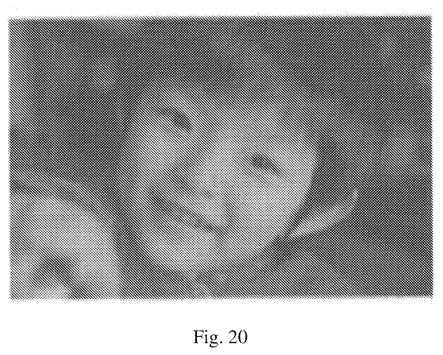

From Example 3 and Comparative Example 1, the inkjet printing papers were evaluated in terms of printing clarity and performance. Related results are provided in FIG. 4 to FIG. 19.

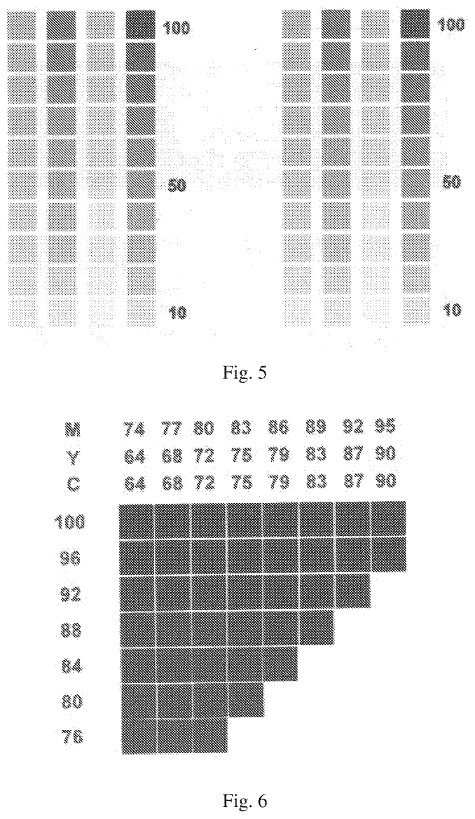

FIG. 4 shows the printing of a portion of a reference image from Example 3. FIG. 5 shows the same image for Comparative Example 1. As can be seen, Example 3 shows relatively higher values of color density (i.e., the density value of the solid regions are relatively high). Further, the dot density (generally refers to a halftone region reflection density) are superior to those of comparative Example 1's ink jet paper.

FIG. 6 shows Example 3's printing performance relative to a grid of black and gray squares from a reference image.

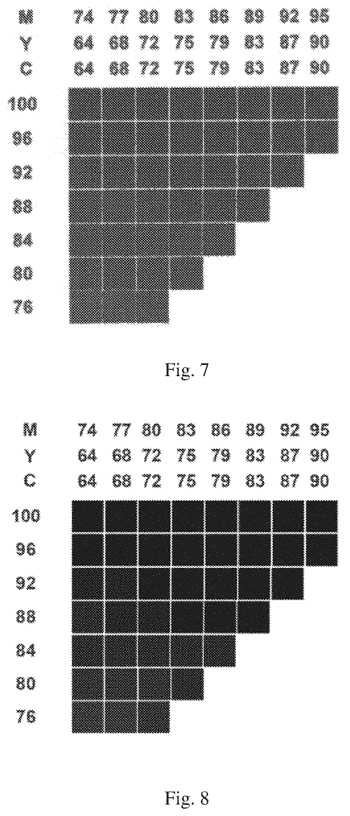

FIG. 7 is a related portion of a printed reference image from the printed sheet of Comparative Example 1.

FIG. 8 is shows the electronic image from the original reference image. FIG. 8 is used as a standard to evaluate the quality of the test patterns printed. The grid of dark blocks is formed from square blocks each with sides about 4.72 mm in length, and the gap between the blocks is about 0.32 mm wide. The width of the top two rows of 8 squares from edge to edge is 40 mm. The color of the squares varies, with CMY values for each column listed above the columns, and K values (black intensity) listed for each tow in labels at the left.

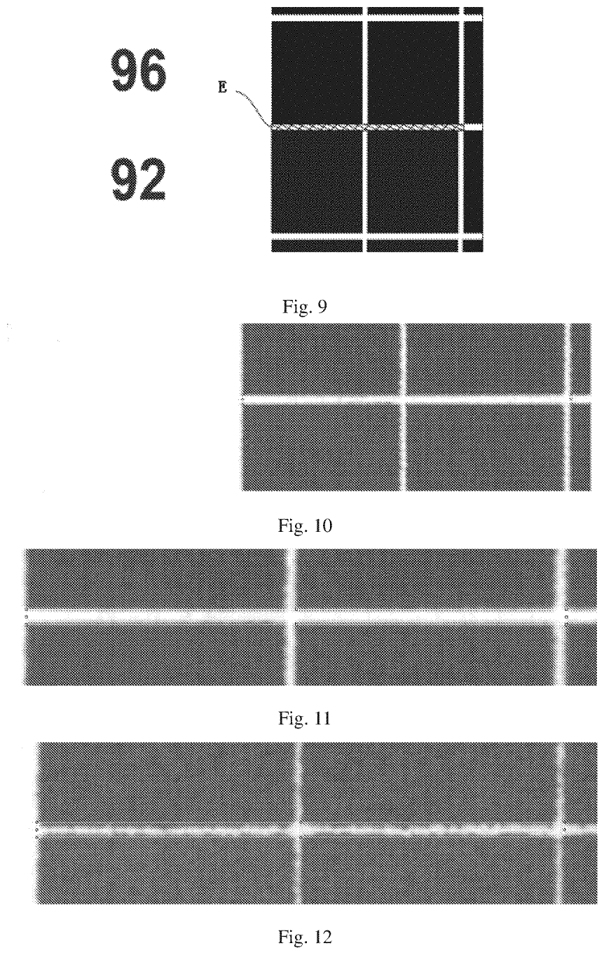

FIG. 9 depicts the portion of the original reference image used for evaluation of the Gap Test. The test is conducted by analyzing a particular section of the printed reference grid, corresponding to the location of a white region on the reference image between the second and third rows from the top and extending from the left side of the grid to the beginning of the third column of squares. The target region for measurement, the “measurement zone,” is shown in the rectangle filled with hatched lines over a portion of the reference grid, as shown in FIG. 9. On printed images, it corresponds to an area of 0.32 mm tall by 10.08 mm wide. On an image scanned at 600 dpi, the measurement zone corresponds to a region of about 7.8 pixels by 245 pixels, but to use a whole number of pixels and avoid requiring the measurement area even with perfect printing to overlap with some of the black ink of the ideal reference image, the pixel height is rounded down to 7 pixels instead of being rounded up to 8. Thus, on 600 dpi scanned images, a measurement zone of 7 by 245 pixels is a reasonable approximation of the idealized measurement zone as defined on the reference image.

FIG. 10 shows the relevant portion of the printed reference image on the paper of Example 3.

FIG. 11 is an enlarged view of the measurement region of FIG. 10 for Example 3.

FIG. 12 shows a portion of a reference image printed on a commercial New Page ink-jet paper.

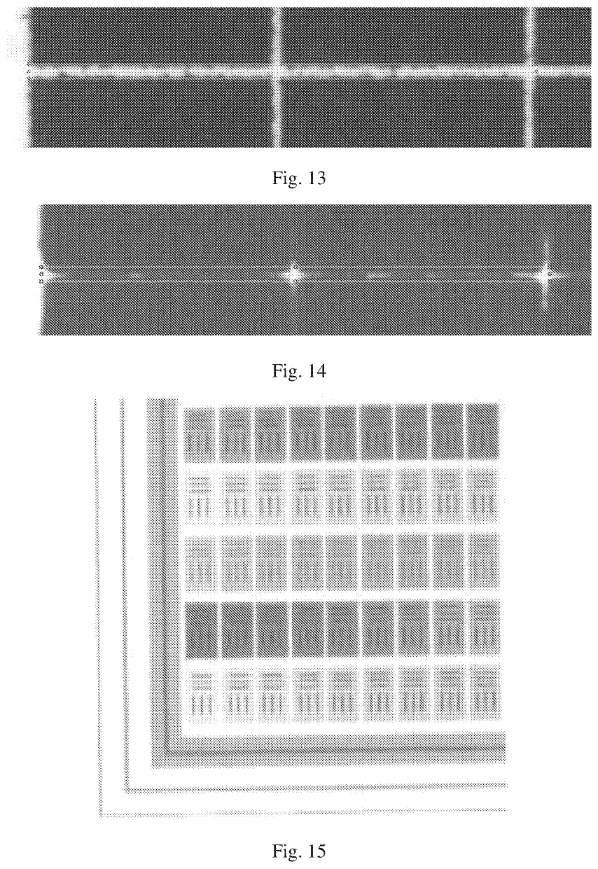

FIG. 13 shows a portion of a reference image printed on a commercial Mitsubishi ink-jet paper.

FIG. 14 shows a portion of a reference image printed on an early experimental form of ink-jet paper from Gold East Paper.

### Determining Gap Test Grayscale Value

After printing the reference image onto a selected paper substrate, the printed image is scanned electronically to obtain an image file. A Hewlett-Packard LaserJet M1213nf multi-functional printer is used, which has a scanner integrated in the system. Scanning is done at a resolution of 600 dpi. Image files are stored in TIFF format to preserve the quality of the scanned image without loss from compression.

Measurement of the gray-scale color of the scanned printed image in the above-mentioned measurement zone is made using a public domain image analysis tool, ImageJ (Wayne Rasband, National Institutes of Health, United States, version 1.52d), processed on a Windows 7 machine. Using a scanned image with x and y axes aligned the x and y axes of the computer screen running ImageJ (image rotation of up to 1 degree may be needed to ensure good alignment, given natural variability that can occur in scanning images), the average gray-scale color in the measurement zone is obtained by simply applying the “Measurement” function for the selected measurement zone. A value of 255 corresponds to pure white, the ideal result that can be obtained from a perfectly printed reference image on pure white paper. A value of 0 corresponds to pitch black.

The measurement area is vertically centered over the boundary between the two rows of black squares, and if there is doubt over the exact vertical location due to blurring, it can be adjusted up or down by one pixel and the location that gives the lightest average gray-scale value is selected.

FIG. 10 shows a portion of the scanned printed image for the inventive paper of Example 3. Small squares indicate “handles” on the ImageJ screen on the selected measurement zone. The measurement zone has dimensions of 7×245 pixels. It can be seen that the content of the selected measurement zone is largely white. The ImageJ measurement gave a mean value of 217.

The New Page ink jet sheet used for the printed squares in FIG. 12 shows more blurring in the gap between the squares, and gave a grayscale value of 164 for the measurement zone, indicating that more black ink had entered the measurement zone due to blurring in the printing. The New Page sheet had a basis weight of 118 gsm and is believed to have a coating rich in nanoparticles.

The results with the Mitsubishi ink jet paper shown in FIG. 13 were similar, with a gray scale value of 168 for the measurement zone. The Mitsubishi sheet had a basis weight of 128 gsm and is believed to have a coating rich in nanoparticles.

A high level of blurring was seen in the early Gold East ink jet prototype in FIG. 14, where the Imagej image analysis measurement of the average grayscale value in the measurement zone gave 107, reflecting a high amount of black ink that had spread laterally into the measurement zone in the gap between two rows of squares in the printed reference image. The early Gold East ink jet prototype had a basis weight of 118 gsm, and calcium chloride and calcium carbonate were used in the coating. Fortunately, the poor results in the early trial were overcome with the discoveries leading to the present invention, where excellent print quality can be obtained without the need for using nanoparticles or high levels of aluminum salts, which can be undesirable for environmental or other reasons.

In general, the ink jet papers of the present invention may provide a Gap Test Grayscale Value of 180 or greater, 190 or greater, 200 or greater, or 210 or greater may be achieved with the inventive method. Note that the upper limit of the test inherently is 255, so it is understood that “180 or greater” means “from 180 to 255.” In practice, the unprinted portions of a scanned paper sheet will rarely be at maximum whiteness, and thus in practice the upper limit for regions completely free of ink may be less than 255, such as about 235, about 240, about 245 or about 250. Thus, in practice, a paper within the scope of the present invention may display a Gap Test Grayscale Value from 180 to about 250 or from 180 to 245.

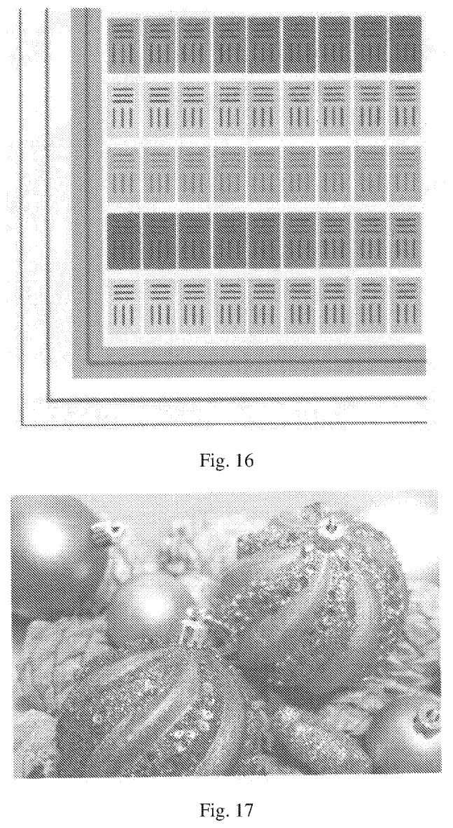

Further comparisons in print quality can be seen in additional portions of the printed reference image as we compare the printed results for Example 3 in FIGS. 15, 17, and 19 with the same portions of the printed reference image for Comparative Example 1 in FIGS. 16, 18, and 20, respectively. In each case, the inventive ink-jet paper of Example 3 gives superior printing results, and achieves this improvement in color density, clarity, color saturation, etc., without relying on expensive nanoparticles.

### CONCLUDING REMARKS

Although the invention has been described with reference to particular embodiments, this description is not meant to be construed in a limiting sense. Various modifications of the disclosed embodiments as well as alternative embodiments of the invention will become apparent to persons skilled in the art. It is therefore contemplated that the appended claims will cover such modifications or embodiments that fall within the scope of the invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is generally also intended to mean “about 40 mm.”

All documents cited in the specification are, in relevant part, incorporated herein by reference to the extent it is not contradictory herewith. The citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

1. A coating color for ink-jet paper, comprising on a bone-dry weight basis: 100 parts pigment particles, 5 to 12 parts adhesive, 0.5 to 10 parts cationic polymer, and an anionic dispersing agent, wherein the adhesive comprises a silane-modified polyvinyl alcohol, the pigment particles comprise one or more of precipitated calcium carbonate, ground calcium carbonate, kaolin, calcined clay, titanium dioxide and talcum powder, the pigment particle surface charge is within the range of −100 to 0 μeq/L, and the pigment has a D50 particle size in the range of 0.4 to 0.8 μm.

2. The coating color of claim 1, wherein at least 60% by weight of the pigment particles have a particle diameter of at least 0.2 and wherein at least 50% by mass of the pigment particles have a particle diameter in the range of 0.2 to 2 μm.

3. The coating color of claim 1, wherein the anionic dispersing agent is selected from one or more of an acrylic acid copolymer aqueous dispersion, acrylic polymers, poly dimethyl diallyl ammonium chloride, and polyamine quaternary ammonium salts.

4. The coating color of claim 1, wherein the silane modified polyvinyl alcohol has a degree of polymerization from 500 to 2000.

5. The coating color of claim 1, wherein the cationic polymer is selected from of one or more of the group consisting of polyethyleneimine, poly hydroxypropyl dimethyl ammonium chloride, poly quaternary ammonium salts, polyvinylpyridine, poly amine sulfones, poly (2-hydroxyethyl methacrylate), poly acrylic acid dialkyl amino ethyl acrylate, poly (2-hydroxyethyl) methacrylamide, poly (2-hydroxyethyl) acrylamide, poly epoxy amine, polyamide, dicyandiamide-formaldehyde condensates, polyethylene amine, poly allyl amine and salts thereof, poly diallyl dimethyl ammonium chloride, a copolymer formed by diallyl dimethyl ammonium chloride and acrylamide monomers, poly diallylmethylamine hydrochloride, dimethyl amine-epichlorohydrin condensation polymers, polycondensates formed by diethylene triamine-epoxy chloropropane polycondensate aliphatic mono amines or aliphatic polyamine with epoxy halogen propane compounds.

6. The coating color of claim 5, wherein the cationic polymer has a weight average molecular weight of from 400 to 100,000.

7. The coating color of claim 1, further comprising a water resistant agent comprising one or more of epoxies, amino zirconium carbonate and poly ammonia polyureas.

8. The coating color of claim 7, wherein the relative amount of water resistant agent is 0.2 to 3 parts on a bone dry basis, relative to said 100 parts of pigment.

9. An ink-jet printing paper comprising: a paper basesheet having two sides, at least one side of which having a surface coating, wherein the surface coating is made from a coating color comprising the following raw material components, on a bone-dry basis: 100 parts of pigment, 5 to 12 parts of adhesive and 0.5 to 10 parts of cationic polymer; and further comprising an anionic dispersant, wherein the adhesive comprises a silane modified polyvinyl alcohol, the pigment comprises at least one of precipitated calcium carbonate, ground calcium carbonate, porcelain clay, calcined clay, titanium dioxide and talcum powder, and wherein the pigment has a D50 particle size from 0.4 to 0.8 μm, and wherein at least 60% by weight of the pigment particles have a particle diameter of 0.2 μm or greater, and at least 50% by weight of the pigment particles have a particle diameter from 0.2 μm to 2 μm; and wherein the ink-jet printing paper under the condition of solid color block printing has a black color density greater than 1.1.

10. The ink-jet printing paper of claim 9, wherein solid color blocks printed on the ink-jet printing paper have a Gap Test Grayscale Value of at least 180.

11. The ink-jet printing paper of claim 9, wherein solid color blocks printed on the ink-jet printing paper have a Gap Test Grayscale Value of at least 200.

12. The ink-jet printing paper of claim 9, wherein the pigment particle surface charge of the pigments used to prepare the coating color is in the range of −100 to 0 μeq/L.

13. The ink-jet printing paper of claim 9, wherein the anionic dispersing agent comprises one or more of an acrylic acid copolymer aqueous dispersion, acrylic polymers, poly dimethyl diallyl ammonium chloride and polyamine quaternary ammonium salts.

14. The ink-jet printing paper of claim 9, wherein the silane modified polyvinyl alcohol has a polymerization degree ranging from 500 to 2000, and wherein at least 70% by weight of the pigment particles have a particle diameter from 0.2 μm to 2 μm.

15. The ink-jet printing paper of claim 9, wherein the cationic polymer is selected from one or more of the group consisting of: polyethyleneimine, poly hydroxypropyl dimethyl ammonium chloride, poly quaternary ammonium salt, polyvinylpyridine, poly amine sulfones, poly (2-hydroxyethyl methacrylate), poly acrylic acid dialkyl amino ethyl acrylate, poly (2-hydroxyethyl) methacrylamide, poly (2-hydroxyethyl) acrylamide, poly epoxy amine, polyamide, dicyandiamide-formaldehyde condensates, polyethylene amine, poly allyl amine and its hydrochloride salt, poly diallyl dimethyl ammonium chloride, a copolymer formed by diallyl dimethyl ammonium chloride and acrylamide monomers, poly (diallylmethylamine hydrochloride, dimethyl amine-epichlorohydrin condensation polymers, polycondensates formed by diethylene triamine-epoxy chloropropane polycondensate aliphatic mono amine or aliphatic polyamine with epoxy halogen propane compound.

16. The ink-jet printing paper of claim 15, wherein the cationic polymer has a weight average molecular weight of from 400 to 100,000.

17. The ink-jet printing paper of claim 9, wherein the coating color further comprises a water resistant agent comprising at least one of epoxy resin, amino zirconium carbonate and poly ammonia polyurea.

18. The ink-jet printing paper of claim 17, wherein the relative amount of water resistant agent in the coating color is from 0.2 to 3 parts on a bone dry basis, relative to said 100 parts of pigment.

19. The ink-jet printing paper of claim 9, wherein the paper basesheet comprises a base paper or a coated paper, and the roughness of the basesheet prior to application of the surface coating is from 4.0 to 8.0 μm.

20. The ink-jet printing paper of claim 19, wherein when the paper basesheet is an uncoated base paper, the coating amount of the surface coating is from 20 gsm to 100 gsm, and when the paper basesheet is a coated paper, the coating amount of the surface coating is from 8 gsm to 15 gsm.
